(19) United States
(12) Patent Application Publication
(10) Pub. No.: US 2020/0353832 A1
(43) Pub. Date: Nov. 12, 2020

(54) DEEP NEURAL NETWORK BASED DRIVING ASSISTANCE SYSTEM

(71) Applicant: Byton North America Corporation, Santa Clara, CA (US)

(72) Inventors: Xinhua Xiao, Santa Clara, CA (US); Wesley Shao, Cupertino, CA (US)

(21) Appl. No.: 16/407,025

(22) Filed: May 8, 2019

(51) Int. Cl. B60L 53/36; G06N 3/04; B60L 53/12; G05D 1/00; G05D 1/02; B62D 15/02

(52) U.S. Cl. CPC B60L 53/36; G06N 3/04; G06N 3/0445; G06N 3/0454; B60L 53/12; G05D 1/0088; B60L 2240/622; B62D 15/0285; G05D 1/0231; G05D 1/0255; G05D 1/027; G05D 1/0278; G05D 1/0225

(57) ABSTRACT

Deep neural network (DNN) based driving assistance system is disclosed. For one example, a vehicle data processing system includes one or more sensors and a driving assistance system. The one or more sensors obtain data describing an environment around a vehicle. The driving assistance system is coupled to the one or more sensors and configured to detect continuously a designated object in the environment around the vehicle based on the captured data from the one or more sensors using a deep neural network (DNN). The driving assistance system is also configured to output commands from the DNN used to autonomously steer the vehicle to the designated object in the environment to enable coupling of the vehicle with the designated object, e.g., a charging pad for wireless charging.

### FIELD

Embodiments and examples of the invention are generally in the field vehicles with autonomous driving and data processing systems for autonomous driving. More particularly, embodiments and examples of the invention relate to a deep neural network (DNN) based driving assistance system.

### BACKGROUND

One type of vehicle is an electric powered vehicle that is gaining popularity due to its use of clean energy. Electric vehicles use a rechargeable battery to power an inductive motor that drives the vehicle. The rechargeable battery can be charged by being plugged into an electrical outlet or wirelessly by way of an inductive charging system. For a wireless or inductive charging system, a vehicle can be electrically coupled to a charging spot or pad to receive electrical power magnetically from the charging system to recharge its battery. Accurate alignment with the charging pad is essential to have the necessary coupling strength for inductive charging to properly recharge the vehicle battery. This requires a driver to manually maneuver the vehicle and accurately align a magnetic attractor under the vehicle with a magnet on the charging spot or pad to recharge the battery. The magnetic attractor under the vehicle is typically out of sight of the driver and, as a result, accurate positioning of the magnetic attractor by driver such that the vehicle maneuvers over the charging spot or pad can be difficult for proper alignment during charging.

### SUMMARY

Embodiments and examples of a deep neural network (DNN) based driving assistance system. The disclosed embodiments and examples can be for an end-to-end DNN or a DNN having intermediate outputs. For one example, a vehicle data processing system includes one or more sensors and a driving assistance system. The one or more sensors obtain data describing an environment around a vehicle. The driving assistance system is coupled to the one or more sensors and configured to detect continuously a designated object in the environment around the vehicle based on the captured data from the one or more sensors using a deep neural network (DNN). The driving assistance system is also configured to output commands from the DNN to autonomously steer the vehicle to the designated object in the environment to enable proper coupling of the vehicle with the designated object.

For one example, the designated object includes a charging pad of a wireless charging system, and the driving assistance system can be a charging assistance system to detect continuously the charging pad and to output commands to autonomously steer the vehicle to couple with the charging pad and enable wireless charging with the wireless charging system for recharging an electric battery of the vehicle. For other examples, the designated object can be a trailer hitch component, cable charging component, gas filling component or other device or component for coupling with the vehicle. The driving assistance system can be configured to output commands from the DNN to autonomously steer the vehicle to any of these designated objects in the environment to enable coupling of the vehicle with the designated objects.

For one example, the one or more sensors can include at least one camera, light detection and ranging device (LIDAR), ultrasonic devices, inertia measurement unit (IMU), and/or global positioning device (GPS). The camera can be any type of camera (e.g., surround camera, 2D or 3D camera, infrared camera, or night vision camera) to capture image data surrounding the vehicle including the designated object. The LIDAR can measure distance to the designated object by illuminating the designated object with a laser. The ultrasonic device can detect objects and distances using ultrasound waves. The IMU can collect angular velocity and linear acceleration data, and the GPS device can obtain GPS data and calculate geographical positioning of the vehicle.

For one example, a DNN includes a convolutional neural network (CNN) to detect the designated object in the data from the one or more sensors and a recurrent neural network (RNN) to track the designated object and output commands to a steering control system to steer the vehicle to enabling coupling with the designated object. The DNN can further include one or more sub-networks to detect obstacles or other objects in the environment based on the data from the one or more sensors. For one example, the driving assistance system can receive initialization information regarding location of the designated object from a database. Information regarding the designated object or other objects can be updated in the database.

Other devices, systems, methods and computer-readable mediums for end to end deep neural networks based charging assistance system are described.

### BRIEF DESCRIPTION OF THE DRAWINGS

The appended drawings illustrate examples and are, therefore, exemplary embodiments and not considered to be limiting in scope.

FIG. 1A illustrates one example of a vehicle environment having a driving assistance system.

FIG. 1B illustrates one example of a network topology for the vehicle of FIG. 1A.

FIG. 2 illustrates one example interior control and display environment of the vehicle of FIGS. 1A-1B.

FIG. 3 illustrates one example block diagram of a data processing or computing system architecture for a vehicle.

FIG. 4 illustrates one example block diagram of driving assistance system for a vehicle having a deep neural network (DNN).

FIG. 5A illustrates one example of a convolutional neural network (CNN) of a DNN to detect a designated object in an environment of a vehicle.

FIG. 5B illustrates one example of a recurrent neural network (RNN) of a DNN to track a designated object from a CNN.

FIG. 5C illustrates one example of a sub-network of a DNN to detect obstacles or other objects in an environment of a vehicle.

FIG. 5D illustrates one example of a training model for a DNN.

FIG. 5E illustrates one example of a DNN system to autonomously steer or maneuver a vehicle to a designated object.

FIG. 6 illustrates one example flow diagram of an operation to autonomously steer or maneuver a vehicle to a designated object.

FIG. 7 illustrates one example of a flow diagram of an operation to detect obstacles or other objects in the environment of a vehicle.

### DETAILED DESCRIPTION

Deep neural network (DNN) based driving assistance system is disclosed. Deep neural networks (DNNs) are disclosed that learn features of designated objects or other objects for coupling with a vehicle based on statistical structures or correlations within input sensor data. The learned features can be provided to a mathematical model that can map detected features to an output. The mathematical model used by the DNN can be specialized for a specific task to be performed, e.g., detecting and tracking a designated object, e.g., a charging pad for wireless charging. The disclosed embodiments or examples can implement end-to-end DNN driving assistance or a DNN with intermediate outputs for driving assistance.

For one example, a vehicle data processing system includes one or more sensors and a driving assistance system. The one or more sensors obtain data describing an environment around a vehicle. The driving assistance system is coupled to the one or more sensors and configured to detect and track a designated object in the environment around the vehicle based on the captured data from the one or more sensors using a DNN. The driving assistance system is also configured to output commands from the DNN used to autonomously steer or maneuver the vehicle to the designated object in the environment to enable coupling of the vehicle with the designated object.

For one example, the driving assistance system can be used for wireless charging assistance to detect a charging pad in an environment surrounding the vehicle that is coupled to a wireless charging system. The driving assistance system can use a DNN to detect and track the charging pad and output commands used to autonomously steer the vehicle to the charging pad for enabling wireless coupling for recharging an electric battery of the vehicle without requiring a magnetic attractor. The vehicle can be coupled to other designated objects such as, for example, a trailer hitch component, cable charging component, gas filling component or like components or devices such that the driving assistance system outputs commands used to autonomously steer or maneuver the vehicle to any of these designated objects using the DNN. By using a DNN, a driving assistance system can provide an end to end operation for autonomously steering or maneuvering a vehicle to a designated object such as, e.g., a charging pad for wireless charging.

As set forth herein, various embodiments, examples and aspects will be described with reference to details discussed below, and the accompanying drawings will illustrate various embodiments and examples. The following description and drawings are illustrative and are not to be construed as limiting. Numerous specific details are described to provide a thorough understanding of various embodiments and examples. However, in certain instances, well-known or conventional details are not described in order to provide a concise discussion of the embodiments and examples.

### Exemplary Vehicle with Driving Assistance System

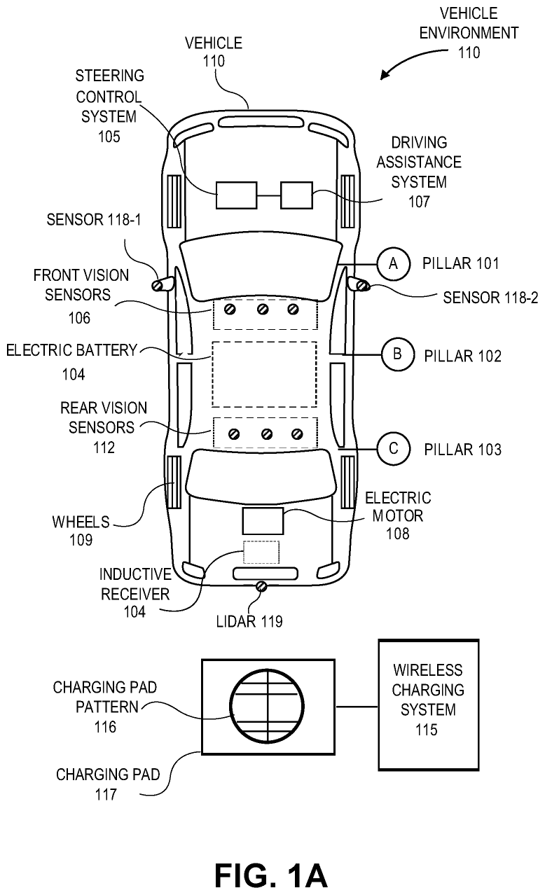

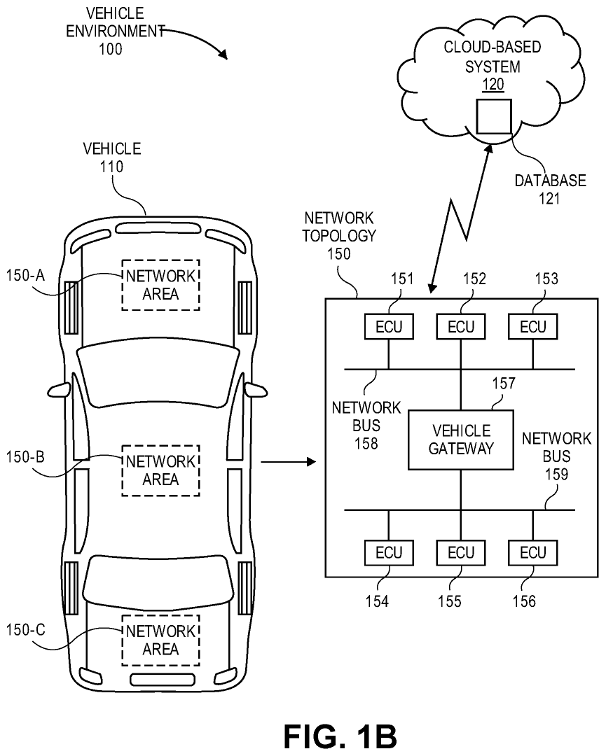

FIG. 1A illustrates one example of a vehicle environment 100 showing a vehicle 110 having an electric battery 104 coupled to an electric motor 108. The electric motor 108 receives power from electric battery 104 to generate torque and turn wheels 109. For the example of FIG. 1A, vehicle 110 is shown as an electric vehicle, yet the driving assistance system 107 and steering control system 105 disclosed herein can be implemented for any type of vehicle such as a gasoline, hybrid or electric vehicle with varying degrees of autonomous or assisted driving capabilities. Referring to FIG. 1A, although vehicle 110 is shown with one electric motor 108 powered by electric battery 104 for a two-wheel drive implementation, vehicle 110 can have a second electric motor for a four-wheel drive implementation. In this example, electric motor 108 is located at the rear of vehicle 110 to drive back wheels 109 as a two-wheel drive vehicle. For other examples, another electric motor can be placed at the front of vehicle 110 to drive front wheels 109 as a four-wheel drive vehicle implementation. Vehicle 110 can allow for autonomous driving (AD) electric car or a semi-autonomous driving to maneuver vehicle 110 to be coupled with a designated object, e.g., charging pad 117 for wireless charging by wireless charging system 115.

For one example, electric motor 108 can be an alternating current (AC) induction motors, brushless direct-current (DC) motors, or brushed DC motors. Exemplary motors can include a rotor having magnets that can rotate around an electrical wire or a rotor having electrical wires that can rotate around magnets. Other exemplary motors can include a center section holding magnets for a rotor and an outer section having coils. For one example, when driving wheels 109, electric motor 108 contacts with electric battery 104 providing an electric current on the wire that creates a magnetic field to move the magnets in the rotor that generates torque to drive wheels 109. For one example, electric battery 104 can be a 120V or 240V rechargeable battery to power electric motor 108 or other electric motors for vehicle 110. Examples of electric battery 104 can include lead-acid, nickel-cadmium, nickel-metal hydride, lithium ion, lithium polymer, or other types of rechargeable batteries. For one example, electric battery 104 can be located on the floor and run along the bottom of vehicle 110. For one example, steering control system 105 can control electric motor 108 and wheels 109 based on commands from driving assistance system 107.

As a rechargeable battery, for one example, electric battery 104 can be charged wirelessly using a wireless charging system 115 connected to a charging pad 117 having a charging pad pattern 116. Wireless charging system 115 and charging pad 117 can be located in a garage, parking lot, gasoline station or any location for wireless charging vehicle 110. Wireless charging system 115 can have alternating current (AC) connectors coupled to a power source that can charge a 120V or 240V rechargeable battery. For example, wireless charging system 115 can provide kilowatts (kW) of power to charging pad 117 such as, e.g., 3.7 kW, 7.7 kW, 11 kW, and 22 kW of power to inductive receiver 104 of vehicle 110. For one example, charging pad 117 with charging pad pattern 116 is a designated object in the environment for coupling with vehicle 110. For example, driving assistance system 107 of vehicle 110 can detect the designated object (e.g., charging pad 117 with charging pad pattern 116) and continuously track the designated object using a deep neural network (DNN) to output commands including steering commands, braking commands, transmission commands, switching-off motor commands, etc. Each of these commands can be forwarded to respect subsystems of vehicle 110 to control their respective functions, e.g., braking, powertrain and steering.

For one example, steering control system 105 receives and processes commands from driving assistance system 107 to output steering signals such as forward, backward, stop, velocity, yaw direction, yaw velocity, etc. to steering subsystems of vehicle 110 to perform respective functions. In this way, driving assistance system 107 and steering control system 105 can be used to autonomously steer or maneuver vehicle 110 such that inductive receiver 104 is positioned substantially and directly above charging pad 117 to receive electric power inductively by way of wireless charging system 115. The DNN used by driving assistance system 107 can be trained to detect and track other designated objects in the environment for coupling with vehicle 110 including a trailer hitch component, cable charging component, gas filling component or other device or component for coupling with vehicle 110.

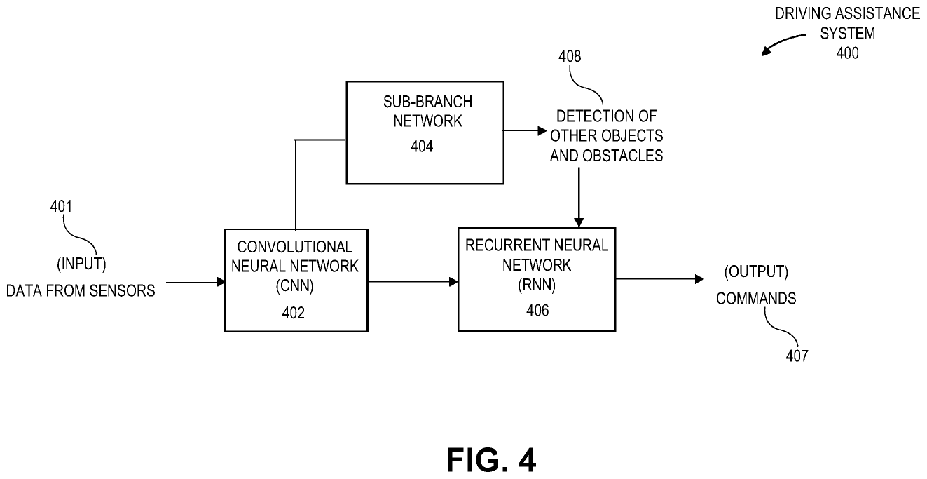

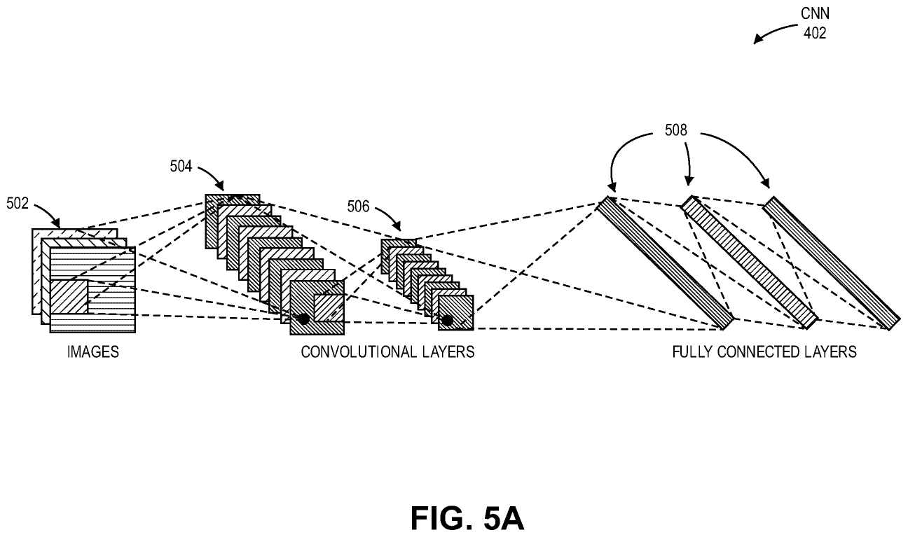

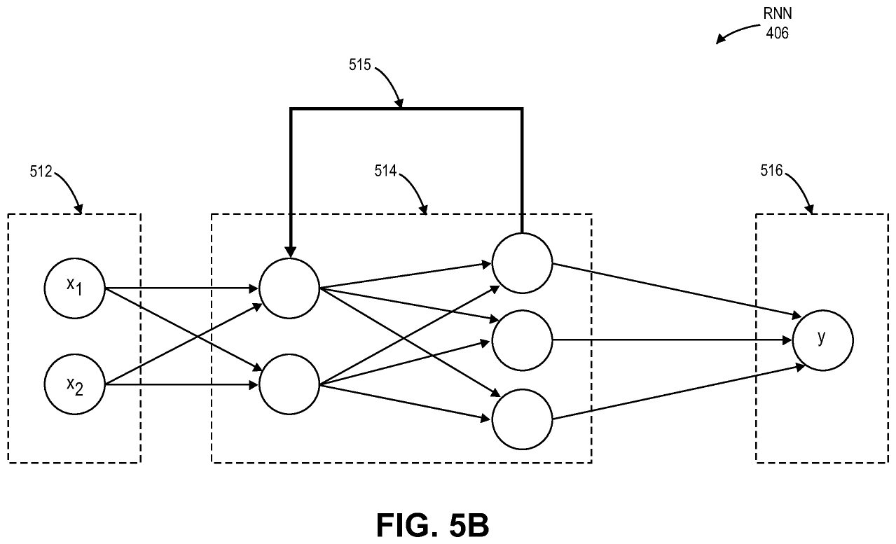

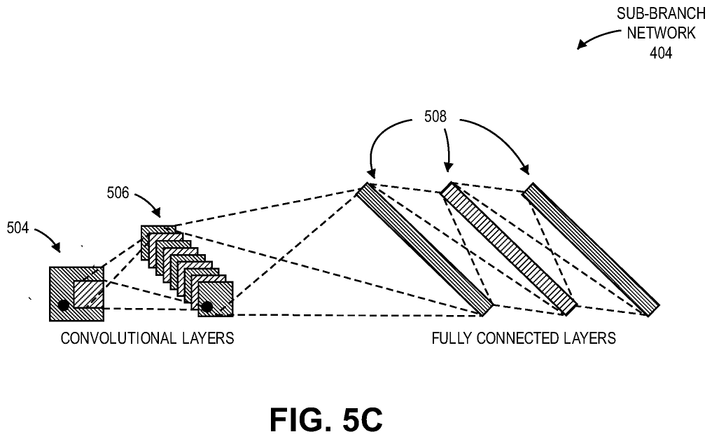

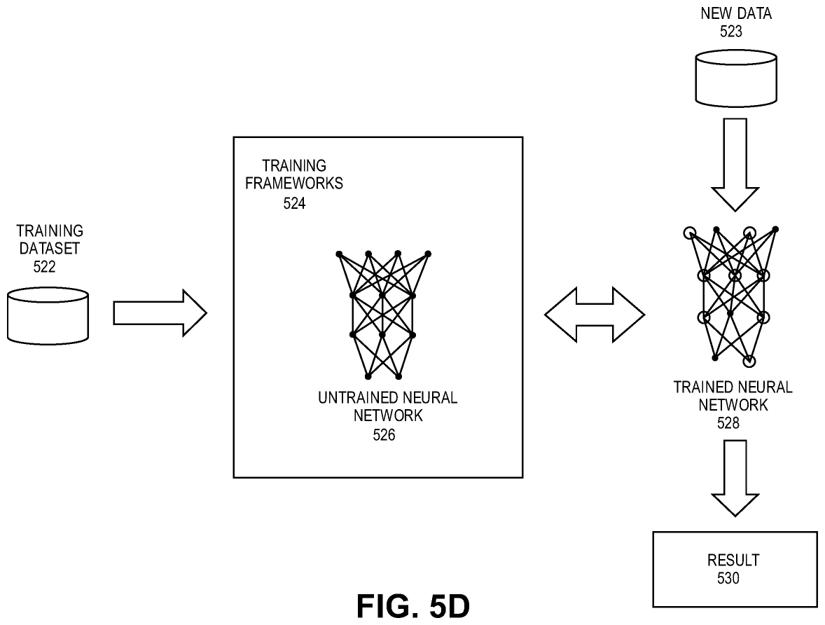

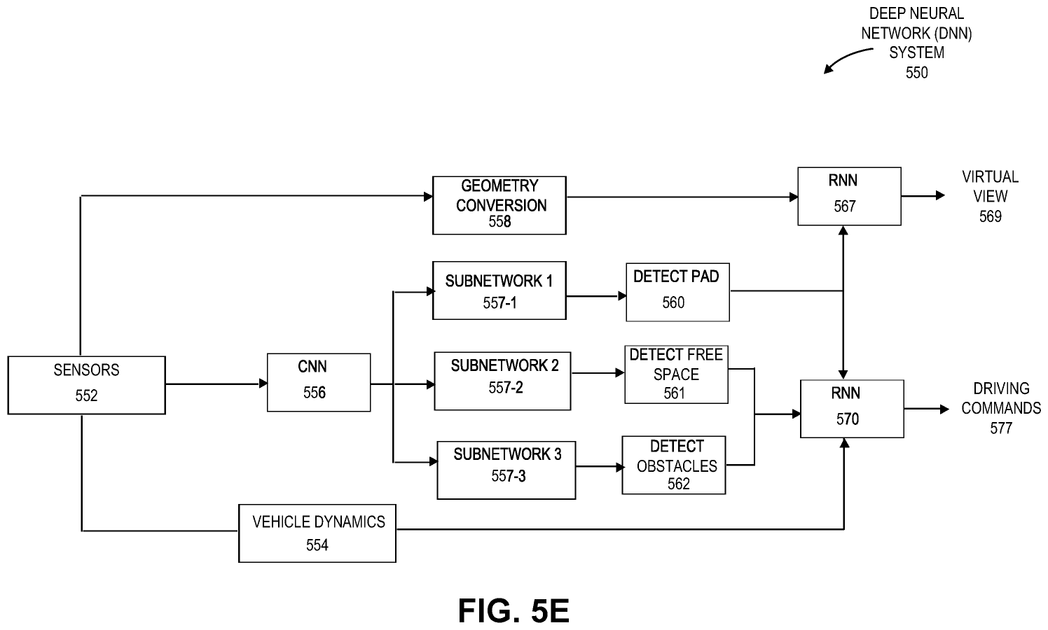

For one example, driving assistance system 107 can use rear vision sensors 112 near pillar C (103) to capture images of charging pad 117 and charging pad pattern 116 including the environment around or surrounding wireless charging system 115. Driving assistance system 107 can also use front vision sensors 106 near pillar A (101) to capture images in front of vehicle 110. Front and rear vision sensors 106 and 112 can include any type of camera to capture images such as a two or three dimensional (2D or 3D) camera, infrared camera, night vision camera or a surround view or stereo camera to capture a 360° degree surround image around vehicle 110. Driving assistance system 107 inputs those captured images (e.g., input feature maps) to deep neural networks (DNNs) disclosed herein that detects features (e.g., charging pattern 116 on charging pad 117) in the images to output commands to steering control system 105 in order to autonomously steer and maneuver vehicle 110 such that inductive receiver 104 is positioned over charging pad 117 for wireless charging. By using a DNN (e.g., as disclosed in FIGS. 4 and 5E), an end to end technique can be achieved that do not require a driver to manually steer vehicle 1110 over the charging pad 117, but rather driving assistance system 107 can autonomously steer or maneuver vehicle 110 for wireless charging. DNNs can be trained to detect any type of object including a charging pad, a trailer hitch component, cable charging component, gas filling component or other device or component and autonomously steer or maneuver vehicle 110 for coupling.

For one example, driving assistance system 107 and steering control system 105 can be one or more programs running on a computer or data processing system including one or more processors, central processing units (CPUs), system-on-chip (Soc) or micro-controllers and memory to run or implement respective functions and operations. For other examples, driving assistance system 107 and steering control system 105 can each be an electronic control unit (ECU) including a micro-controller and memory storing code to implement the end to end driving assistance including wireless charging assistance as disclosed herein. Driving assistance system 107 can implement WiFi, cellular or Bluetooth communication and related wireless communication protocols and, in this way, driving assistance system 107 can have access to other services including cloud services (e.g., cloud-based system 120 and database 121 shown in FIG. 1B). For one example, database 121 in cloud-based system 120 can store training data for the DNN and receive updates to any DNN used by the driving assistance system 107 of vehicle 110. For other examples, database 121 can be located within vehicle 110 or accessed by vehicle 110 by way of a network such as network topology 150.

For other examples, driving assistance system 107 can use additional data captured from other sensors to input data to the DNN in order to output commands for autonomously steering vehicle 110 over the charging pad 117. Other sensors can include a light detection and ranging (LIDAR) device 119 at the rear of vehicle 110 that can measure distance to a target by illuminating the target with a pulsed laser. LIDAR device 119 can be positioned in other locations such as on top of vehicle 110 and additional LIDAR devices can be located on vehicle 110 to measure distance of a target object using light. Additional sensors such as sensors 118-1 and 118-2 can be located on either side of vehicle 110 near pillar A (101) and include ultrasonic devices that detect objects and distances using ultrasound waves, and inertia measurement unit (IMU) which can collect angular velocity and linear acceleration data, global positioning system (GPS) device which can receive GPS satellite data and calculate vehicle 110 geographical position and etc. Data from sensors 118-1 and 118-2 can also be input to a DNN used to output commands to steering control system 105 for autonomously steering vehicle 110 over the charging pad 117 or other designated objects for coupling with vehicle 110.

FIG. 1B illustrates one example of a network topology 150 for vehicle 110 in vehicle environment 100 of FIG. 1A. Vehicle 110 includes a plurality of networking areas such as network areas 150-A, 150-B and 150-C interconnecting any number of subsystems and electronic control units (ECUs) according to a network topology 150. Any number of networking areas can be located throughout vehicle 100 and each networking area can include any number of interconnected ECUs and subsystems. Referring to FIG. 1B, for one example, network topology 150 includes interconnected ECUs 151-156 for electronic subsystems of vehicle 100 by way of network busses 158 and 159. For one example, ECUs can be a micro-controller, system-on-chip (SOS), or any embedded system that can run firmware or program code stored in one or more memory devices or hard-wired to perform operations or functions for controlling components within vehicle 110. For other examples, driving assistance system 107 and steering control system 105 can each be an ECU coupled to network busses 158 and 159 and communicate with ECUs 151-156, which can include sensors 106, 112, 118-1, 118-2 and 119, within network topology 150.

For one example, one or more ECUs can be part of a global positioning system (GPS) or a wireless connection system or modem to communicate with cloud-based system 120 and database 121. Examples of communication protocols include Global System for Mobile Communications (GSM), General Packet Radio Service (GPRS), CDMAOne, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), Integrated Digital Enhance Network (iDEN), etc. and protocols including IEEE 802.11 wireless protocols, long-term evolution LTE 3G+ protocols, and Bluetooth and Bluetooth low energy (BLE) protocols.

For one example, database 121 can be part of cloud-based system 120 and store initialization or localization or area data for vehicle 110 in which a designated object, e.g., charging pad 117, is located in an environment surrounding vehicle 110 for coupling with vehicle 110. For other examples, database 121 can be located within or accessible by vehicle 110. Database 121 can store location information of service charging stations from maps, driving history related to vehicle 110. Vehicle 110 can have a database that stores such information and can be updated periodically from database 121 that can be located in cloud-based system 120. This database data can be forwarded driving assistance system 107 via a wireless connection or by way of network topology 150. For one example, vehicle 110 can communicate with a server in cloud-based system 120 providing information to vehicle 110 of other possible wireless charging locations and updating a DNN in driving assistance system 107 for an updated charging location. Driving assistance system 107 can use the updated information, e.g., updated DNN computations, to autonomously steer or maneuver vehicle 110 for the updated charging location.

For one example, vehicle 110 can communicate with other vehicles wirelessly, e.g., asking if vehicle is leaving a spot having a designated object for coupling by way of a vehicle-to-vehicle (V2V) communication protocol. For other examples, vehicle 110 can share data wireless from components of a highway and street system infrastructure such as charging stations, RFID readers, cameras, traffic lights, lane markers, street lights, signage, parking meters etc. by way of a vehicle-to-infrastructure (V2I) communication protocol which can assist driving assistance system 107 if related to the surroundings of vehicle 110. Information and data retrieved wireless using V2V and V2I communication protocols can be forwarded to driving assistance system 107 and processed and can be used to assist in detecting a designated object, e.g., charging pad 107, or other objects and obstacles.

For one example, each ECU can run firmware or code or hard-wired to perform its function and control any number of electronic components operating within vehicle 110. For example, ECUs network areas 150-A, 150-B and 150-C can have ECUs controlling electronic components or subsystems for braking, steering, powertrain, climate control, ignition, stability, lighting, airbag, sensors and etc. The ECUs in the different networking areas of vehicle 110 can communicate with each other by way of network topology 150 and network busses 158 and 159. Although two network busses are shown in FIG. 1B, any number of network busses may be used to interconnect the ECUs. For one example, network topology 150 includes network or communication busses 158 and 159 interconnecting ECUs 151 through 156 and coupling the ECUs to a vehicle gateway 157. For one example, vehicle gateway 157 can include a micro-controller, central processing unit (CPU), or processor or be a computer and data processing system to coordinate communication on network topology 150 between the ECUs 151-156. For one example, vehicle gateway 157 interconnects groups (or networks) and can coordinate communication between a group of ECUs 151-153 with another group of ECUs 154-156 on busses 158 and 159. For one example, network topology 150 and busses 158 and 159 can support messaging protocols including Controller Area Network (CAN) protocol, Local Interconnect Protocol (LIN), and Ethernet protocol.

### Exemplary Interior Vehicle Controls and Displays

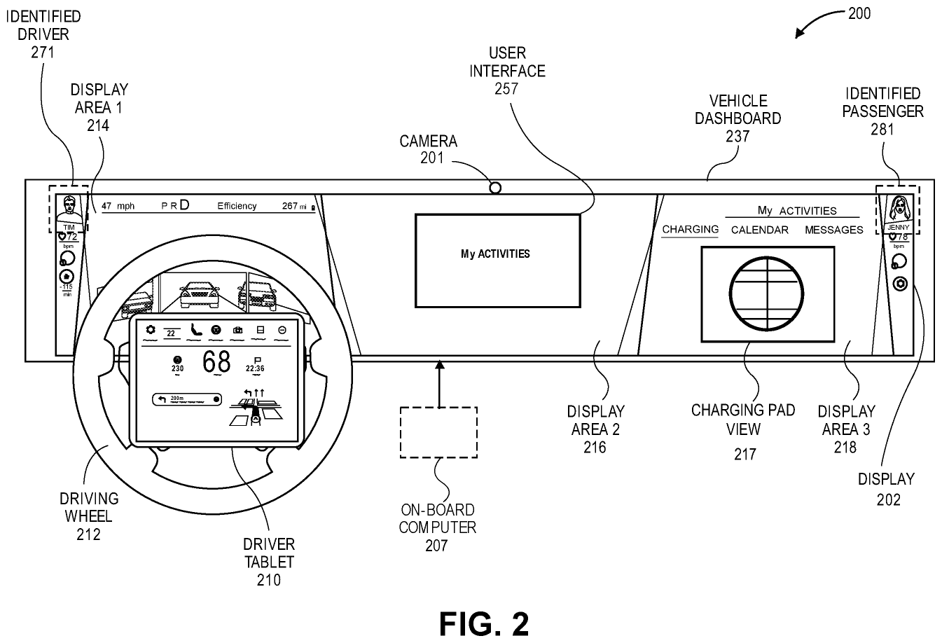

FIG. 2 illustrates one example interior control environment 200 of vehicle 110 showing charging pad view 217 on display 202 of vehicle dashboard 237. Referring to FIG. 2, the interior control environment 200 is shown from a front seat view perspective. For one example, interior control environment 200 includes vehicle dashboard 237 with a driving wheel 212 and display 202. An on-board computer 207 can be located behind vehicle dashboard 237. Display 202 includes three display areas: display area 1 (214), 2 (216) and 3 (218). Vehicle dashboard 237 can include one more computing devices (computers) such as on-board computer 207 to control user interfaces (e.g., user interface 257) on display areas 1 to 3 (214, 216, and 218) including charging pad view 217 with a charging pad pattern 116 and show vehicle 110 approaching charging pad 117 for wireless charging coupling. An identified driver 271 and identified passenger 281 for vehicle 110 can also be shown. For one example, user interface 257 can be a touch-panel interface for “MyActivities” including a function for autonomous wireless charging to a designated object, e.g., charging pad 117 for wireless coupling. For other examples, other functions can include coupling with other objects such as, e.g., a trailer hitch component, cable charging component, or a gas filling component.

For one example, on-board computer 207 can run programs or modules to implement driving assistance system 107 and steering control system 105 to autonomously perform wireless charging by autonomously steering or maneuvering vehicle 110 such that inductive receiver 104 is above charging pad 117. For other examples, on-board computer 207 can receive voice commands that are processed to control interfaces on vehicle dashboard 237. For one example, driver tablet 210 is a tablet computer and can provide a touch screen with haptic feedback and controls. A driver of vehicle 110 can use driver tablet 210 to access vehicle function controls such as, e.g., climate control settings. Driver tablet 210 can be coupled to on-board computer 207 or another vehicle computer or ECU (not shown).

Display 202 can include a light emitting diode (LED) display, liquid crystal display (LCD), organic light emitting diode (OLED), or quantum dot display, which can run substantially from one side to the other side of vehicle dashboard 237. For one example, coast-to-display 202 can be a curved display integrated into and spans the substantial width of dashboard 237 (or coast-to-coast). One or more graphical user interfaces can be provided in a plurality of display areas such as display areas 1 (214), 2 (216), and 3 (218) of coast-to-coast display 202. Such graphical user interfaces can include status menus shown in, e.g., display areas 1 (214) and 3 (218) in which display area 3 (218) shows charging pad view 217. For one example, display area 1 (214) can show rear view, side view, or surround view images of vehicle 110 from one or more cameras, which can be located outside or inside of vehicle 110.

### Exemplary Data Processing and Computing System Architecture

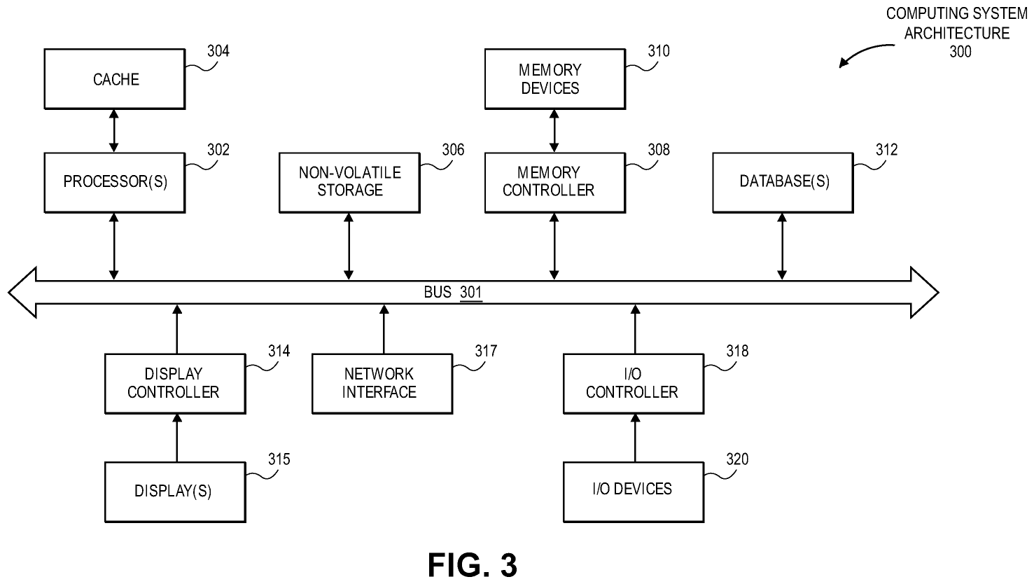

FIG. 3 illustrates one example block diagram of a data processing or computing system architecture 300. Computing system architecture 300 can represent an architecture for on-board computer 207 or any other computer used in vehicle 110 or a computer or server in cloud-based system 120. Although FIG. 3 illustrates various components of a data processing or computing system, the components are not intended to represent any particular architecture or manner of interconnecting the components, as such details are not germane to the disclosed examples or embodiments. Other data processing systems or other consumer electronic devices, which have fewer components or perhaps more components, may be used with the disclosed examples and embodiments.

Referring to FIG. 3, computing system architecture 300, which is a form of a data processing or computer, includes a bus 301 coupled to processor(s) 302 coupled to cache 304, display controller 314 coupled to a display 315, network interface 317, non-volatile storage 306, memory controller 308 coupled to memory devices 310, I/O controller 318 coupled to I/O devices 320, and database(s) 312. Processor(s) 302 can include one or more central processing units (CPUs), graphical processing units (GPUs), a specialized processor or any combination thereof. Processor(s) 302 can retrieve instructions from any of the memories including non-volatile storage 306, memory devices 310, or database 312, and execute the instructions to perform operations described in the disclosed examples and embodiments such as deep neural network (DNN) inference performance and training.

Examples of I/O devices 320 include external devices such as a pen, Bluetooth devices and other like devices controlled by I/O controller 318. Network interface 317 can include modems, wired and wireless transceivers and communicate using any type of networking protocol including wired or wireless WAN and LAN protocols including LTE and Bluetooth standards. Memory device 310 can be any type of memory including random access memory (RAM), dynamic random-access memory (DRAM), which requires power continually in order to refresh or maintain the data in the memory. Non-volatile storage 306 can be a mass storage device including a magnetic hard drive or a magnetic optical drive or an optical drive or a digital video disc (DVD) RAM or a flash memory or other types of memory systems, which maintain data (e.g. large amounts of data) even after power is removed from the system.

For one example, memory devices 310 or database 312 can store user information and parameters related to DNN used by driving assistance system 107 including user information for applications on display 202. Although memory devices 310 and database 312 are shown coupled to system bus 301, processor(s) 302 can be coupled to any number of external memory devices or databases locally or remotely by way of network interface 317, e.g., database 312 can be secured storage in a cloud-based system 120. For one example, processor(s) 302 can implement techniques and operations described herein. Display(s) 315 can represent display 202 in FIG. 2.

Examples and embodiments disclosed herein can be embodied in a data processing system architecture, data processing system or computing system, or a computer-readable medium or computer program product. Aspects, features, and details of the disclosed examples and embodiments can take the hardware or software or a combination of both, which can be referred to as a system or engine. The disclosed examples and embodiments can also be embodied in the form of a computer program product including one or more computer readable mediums having computer readable code which can be executed by one or more processors (e.g., processor(s) 302) to implement the techniques and operations disclosed herein.

### Exemplary Driving Assistance System and Deep Neural Networks DNN

FIG. 4 illustrates one example of a block diagram of a driving assistance system 400 for vehicle 110. Driving assistance system 400 includes a deep neural network (DNN) that includes a front-end convolutional neural network (CNN) 402 to detect a designated object from sensor data, e.g., image data, coupled sequentially to a back-end recurrent neural network (RNN) to track the designated object and to output commands 407 including steering commands, braking commands, transmission commands, switching-off motor commands, etc. Each of these commands can be forwarded to respective subsystems of vehicle 110 to control their respective functions, e.g., braking, powertrain and steering. For one example, steering control system 105 can receive steering commands from RNN 406 to output steering signals such as forward, backward, stop, velocity, yaw direction, yaw velocity, etc. to steering subsystems of vehicle 110 to perform respective functions in order to autonomously steer or maneuver vehicle 110 to a designated object for coupling, e.g., wireless charging pad. For one example, the DNN can have a sub-branch network 404 from CNN 402 to detect any other objects and obstacles 408 useful in training the DNN. Other objects and obstacles 408 can be detected by a sub-branch network 404 that can feed into RNN 406 to track other objects and obstacles 408 in providing output commands 407 and warnings of any detected obstacles while attempting to couple with a designated object.

Referring to FIGS. 1A and 4, data from sensors 401 are input to CNN 402. For one example, rear vision sensors 112 can capture a plurality of images of the environment surrounding the wireless charging system 115 including charging pad 117 which can be considered a designated object. Other types of designated objects can include a trailer hitch component, cable charging component, gas filling component or other like device or component. The image can be capture in short periodic intervals and continuously input to CNN 402. For one example, the rear vision sensors 112 can combine with images from the front vision sensors 106 that can be short range stereo cameras and provide 360° degree surround view images. Alternatively, input data from rear vision sensors 112 or front vision sensors 106 can be added with data from other sensors such as LIDAR 119 and sensors 118-1 and 118-2 that can be ultrasonic devices, inertia measurement unit (IMU), and/or global positioning device (GPS) and input to CNN 402. As further described in FIG. 5D, for one example, the CNN 402 is trained to make filtering computations to detect features of the designated object using CNN techniques. RNN 406 can be trained to make computations using feedback to track the designated object using RNN techniques. Sub-branch network 404 can be trained to make filtering computations to detect obstacles or other objects (e.g., a person or another vehicle) in an environment around vehicle 110 using CNN techniques. The training of these networks can use data from these sensors. For one example, driving assistance system 400 can perform these networks 402, 404 and 406 to output commands 407 during DNN inference performance.

### Convolutional Neural Network CNN

Referring to FIG. 5A and 4, for one example, CNN 402 can be a specialized feedforward neural network to model processing of input sensor data 401 having a known, grid-like topology, such as, e.g., images 502 from rear vision sensors 112 and front vision sensors 106. CNN 402 can include a plurality of convolutional layers 504 and 506, each layer having a plurality of nodes, that are organized into a set of “filters” (which act as feature detectors), and the output of each set of filters is propagated to nodes in successive convolutional layers. At each node and layer, a number of parameters are computed for feature detection that can start with edges and blobs, specific objects (e.g., charging pad 117) and specific patterns (e.g., charging pattern 116). That is, convolutional layers 504 and 506 or other layers can be trained and configured with filters to detect a designated object and a particular pattern of the designated such as, e.g., charging pad 117 having charging pad pattern 116. CNN 402 can use any type of CNN network to detect a designated object such as a fast region CNN network (R-CNN), real-time only look once object detection (YOLO) network, or a single shot multi-box detector (SSD) network used to detect objects within a region or bounding box.

For one example, convolutional layer 504 can provide a first level of filtering of the images for a designated object (e.g., charging pad 117) and convolutional layer 506 can provide a second level filter of the first level of filtering to detect additional features (e.g., charging pad pattern 116). The computations for a CNN include applying the convolution mathematical operation or computations to each filter to produce the output of that filter. CNN 402 can thus use filters of the convolutional layers 504 and 506 to charging pad 117 having charging pad pattern 116, which can be a designated object for coupling with a vehicle. The filters also can be configured to filter images for detection of other types of designated objects described herein. The outputs of the convolutional layers 504 and 506 feed into fully connected layers 508 that can produce an output feature map of detected features of a designated object. For one example, an output feature map can include multi-dimensional data describing a detected object in space and confidences of the detected object type—i.e., is the detected object a charing pad 117 having a charging pattern 116. Such data can be used by CNN 402 to determine that a charging pad 117 has been detected based on confidences that it has the charging pattern 116. For other examples, fully connected layers 508 can be omitted and the output of convolutional layers 504 and 506 can be used by RNN 406 to track the designated object and output steering commands.

### Recurrent Neural Network RNN

Referring to FIG. 5B and 4, RNN 406 can be a family of feedforward neural networks that include feedback connections between layers including long short term memory (LSTM) networks or deep Q-learning (DQN) networks. RNN 406 can enable modeling of sequential data from CNN 402 (e.g., output feature maps) by sharing parameter data across different parts of the neural network. The architecture for a RNN includes cycles that can represent the influence of a present value of a variable on its own value at a future time, as at least a portion of the output data from the RNN is used as feedback for processing subsequent input in a sequence. Such a feature makes RNNs particularly useful as subsequent images of the vehicle environment are fed into the DNN as the vehicle is autonomously steered or maneuvered changing positions and locations in order to couple with a designated object, e.g., charging pad 117. For example, RNN 406 can be trained to track charging pad 117 with charging pattern 116 and to output commands 407 that steer vehicle 110 over charging pad 117 for inductive coupling.

For one example, RNN 406 illustrates an exemplary recurrent neural network in which a previous state of the network influences the output of the current state of the network. The use of RNNs generally revolves around using mathematical models to predict the future based on a prior sequence of inputs. For example, RNN 406 can perform modeling to predict an upcoming steering, braking, or powertrain command of a vehicle based on previous feature maps of a designated object and track that designated object in subsequent data from CNN 402. RNN 406 has an input layer 512 that receives an input vector of a detected designated object from CNN 402, hidden layers 514 to implement a recurrent function, a feedback mechanism 515 to enable a ‘memory’ of previous states, and an output layer 516 to output a result such as, e.g., a steering command, e.g., left, right, straight, yaw rate or velocity.

For one example, RNN 406 can operate on time-steps. The state of the RNN at a given time step is influenced based on the previous time step via the feedback mechanism 515. For example, each time step can be based on data from an image capture one point in time and the next time step can be based on data from an image captured at a subsequent point in time. For a given time step, the state of the hidden layers 514 is defined by the previous state and the input at the current time step. For one example, an initial input (x₁) at a first-time step can be processed by the hidden layer 514. A second input (x₂) can be processed by the hidden layer 514 using state information that is determined during the processing of the initial input (x₁). A given state can be computed as sₜ=ƒ(Uxₜ+Wsₜ₋₁), where U and W are parameter matrices. The function ƒ is generally a nonlinearity, such as the hyperbolic tangent function (Tanh) or a variant of the rectifier function ƒ(x)=max(0, x). Mathematical functions used in the hidden layers 514 of RNN 406 can vary depending on the specific object to track, e.g., charging pad 117 or a hitch or gas filling component. For one example, hidden layers 514 can include spatio-temporal convolution (ST-Conv) layers that can shift along both spatial and temporal dimensions. RNN 406 and input layer 512 can receive input from sensors including images from cameras and vehicle dynamic data such as LIDAR, ultrasonic, inertia, GPS, speed, torque, wheel angle data etc. that can be synchronized with varying time stamps to assist in determining output commands 407. For one example, RNN 406 can be trained for multi-task learning to determine specific output commands 407 for steering vehicle 110 to charging pad 117 or other designated object such as steering commands, stop and accelerate, switch off, or other vehicle commands. RNN 406 can be trained to minimize loss when coupling vehicle 110 to charging pad 117.

### Sub-Branch Network

Referring to FIG. 5C and 4, sub-branch network 404 can be branch or subnetwork of CNN 402 to provide intermediate outputs. Sub-branch network 404 can include a subset of convolutional layers 504 and 506 and fully connected layers 508. Sub-branch network 404 can operate in the same way as CNN 402, but trained to detect obstacles or other objects. For one example, images from front vision sensors 106 and rear vision sensors 112 may include obstacles or other objects (e.g., a person or another vehicle) within the environment of vehicle 110. Sub-branch network 404 can be modeled and trained to detect such obstacles or other objects and provide a warning to a driver. For example, referring to FIG. 2, during charging, display area 3 (218) of display 202 can show a warning of the obstacle or other object to a driver or passenger of vehicle 110. The warning can also be received by driving assistance system 107 to account for the obstacle or other object in coupling with the designated object. For other example, sub-branch network 404 can be trained and configured to detect other types of obstacles or objects such as a charging pad, cables, segmentation of the ground in the surrounding environment, parking lines, etc.

### Training the DNN

FIG. 5D illustrates an exemplary training and deployment for a DNN of driving assistance system 400 of FIG. 4. The DNN of driving assistance system 400 can be trained from end to end or with intermediate outputs for any of the DNNs disclosed herein based on a large training dataset 522. Training dataset 522 can be collected from sensors, e.g., front and rear vision sensors 106 and 112, LIDAR 119, and sensors 118-1 and 118-2 and other vehicle and driver information. Other vehicle and driver information can include data fro other subsystems of vehicle 110 such as its steering control system 105, driving assistance system 107, transmission, braking and motor subsystems, etc. Training dataset 522 can include large amounts of camera data, LIDAR data, ultrasonic, GPS and IMU data, etc. of vehicle 110 being maneuvered to a designated object, e.g., charging pad 117, in order for DNN to be trained so that driving assistance system 400 can output commands to autonomously steer and maneuver the vehicle 110 to the designated object, e.g., charging pad 117 for wireless charging. Training dataset 522 can also include data for training a vehicle to be coupled to other types of designated objects including a trailer hitch component, cable charging component, gas filling component or other device or component for coupling with the vehicle.

Once a given network has been structured for a task in the driving assistance system 400, the neural network is trained using training dataset 522. Training frameworks 524 can be used to enable hardware acceleration of the training process. For example, training frameworks 524 can hook into an untrained neural network 526 and enable the untrained neural net to be trained to detect designated objects in a vehicle environment 100 including charging pad 117 or, alternatively, designated objects such as a trailer hitch component, cable charging component, gas filling component or other device or component for coupling with vehicle 110.

To start the training process, initial weights (filters) may be chosen randomly or by pre-training using a deep belief network. The training cycle can be performed in either a supervised or unsupervised manner. Supervised learning is a learning technique in which training is performed as a mediated operation, such as when training dataset 522 includes input paired with the desired output for the input, or where the training dataset 522 includes input having known output and the output of the neural network is manually graded. The network processes the inputs and compares the resulting outputs against a set of expected or desired outputs. Errors are then propagated back through the system. The training frameworks 524 can adjust to adjust the weights that control the untrained neural network 526. The training frameworks 524 can provide tools to monitor how well the untrained neural network 526 is converging towards a model suitable to generating correct answers based on known input data. The training process occurs repeatedly as the weights of the network are adjusted to refine the output generated by the neural network. The training process can continue until the neural network reaches a statistically desired accuracy associated with a trained neural network 528. The trained neural network 528 can then be deployed to implement any number of machine learning operations such as CNN 402, sub-branch network 404 and RNN 406.

Unsupervised learning is a learning method in which the network attempts to train itself using unlabeled data. Thus, for unsupervised learning the training dataset 522 will include input data without any associated output data. The untrained neural network 526 can learn groupings within the unlabeled input and can determine how individual inputs are related to the overall dataset. Unsupervised training can be used to generate a self-organizing map, which is a type of trained neural network 528 capable of performing operations useful in reducing the dimensionality of data. Unsupervised training can also be used to perform anomaly detection, which allows the identification of data points in an input dataset that deviate from the normal patterns of the data.

Variations on supervised and unsupervised training may also be employed. Semi-supervised learning is a technique in which in the training dataset 522 includes a mix of labeled and unlabeled data of the same distribution. Incremental learning is a variant of supervised learning in which input data is continuously used to further train the model. Incremental learning enables the trained neural network 528 to adapt to the new data 523 without forgetting the knowledge instilled within the network during initial training providing a result 530. Whether supervised or unsupervised, the training process for particularly deep neural networks may be too computationally intensive for a single compute node. Instead of using a single compute node, a distributed network of computational nodes can be used to accelerate the training process.

### DNN System Example

FIG. 5E illustrates one example of a DNN system 550 to autonomously steer or maneuver a vehicle to a designated object such as a charging pad, e.g., charging pad 117. DNN system 550 includes sensors 552 that provide input data to CNN 556 and geometry conversion 558. Sensors 552 can include image data from front and rear vision sensors 106 and 112, LIDAR 119 and sensors 118-1 and 118-2 including ultrasonic devices that detect objects and distances using ultrasound waves and inertia measurement unit (IMU) which can collect angular velocity and linear acceleration data, global positioning system (GPS) device which can receive GPS satellite data and calculate GPS position for vehicle 110. Sensors 552 can include vehicle dynamics 554 that includes information derived from sensors 552 such as vehicle 110 speed that fed into RNN 570.

For one example, CNN 556 receives input from sensors 552 and can process the input using one or more convolutional layers to generate an intermediate feature map. This intermediate feature map can be fed into a plurality of subnetworks such as subnetworks 1-3 (557-1 to 557-3). Subnetwork 1 (557-1) can include one or more convolutional layers to detect a pad 560 (i.e., charging pad 117). Subnetwork 2 (557-2) can include one or more convolutional layers to detect free space 561. Subnetwork 3 (557-3) can include one or more convolutional layers to detect obstacles 562 or other objects. The detected pad 560, free space 561 and obstacles 562 or other objects are fed into RNN 570 that also receives vehicle dynamics 554 and output of RNN 567. RNN 567 receives geometry conversion 558 data that provides a virtual bird's eye view of detected pad 560 and surrounding area. Geometry conversion 558 can receive vehicle 110 sensor data to create the bird's eye view. RNN 570 can track detected pad, 560, free space 561, and obstacles 562 to determine driving commands using bird's eye view from RNN 567 and vehicle dynamics 554.

### Exemplary Designated Object Coupling Operations

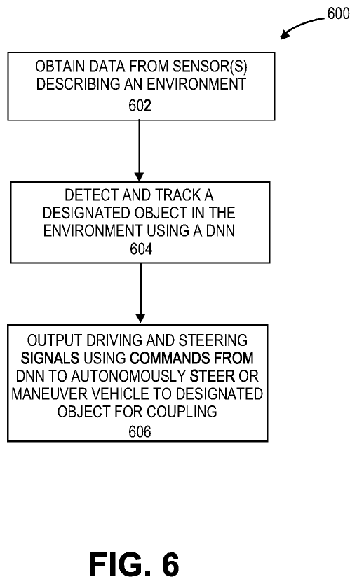

FIG. 6 illustrates one example flow diagram of an operation 600 to autonomously steer or maneuver a vehicle to a designated object. Operation 600 includes operations 602, 604 and 606, which can be implemented by driving assistance system 107 and 400 of FIGS. 1A and 4 within vehicle 100.

Initially, at operation 602, data is obtained from one or more sensors describing an environment of a vehicle, e.g., vehicle 110. For example, images from front and back vision sensors 106 and 112 are obtained. Alternatively, data from other sensors can be obtained such as sensors 118-1 and 118-2 and LIDAR 119. The sensor data is fed into driving assistance system 107.

At operation 604, a designated object is detected and tracked in the environment using a DNN. For example, driving assistance system 107 can feed images from sensor data into CNN 402 that detect (filter) features of a designated object. Referring to FIG. 1A, charging pad 117 can be a designated object and a feature can be charging pad pattern 116. CNN 402 can also be configured or updated to detect features of other designated objects as described herein. The detected features (feature map) are fed into RNN 406 that tracks the features and outputs commands 407 such as, e.g., steering commands, braking commands, transmission commands, switching-off motor commands, etc. Each of these commands can be forwarded to respective subsystems of vehicle 110 to control their respective functions, e.g., braking, powertrain and steering.

At operation 606, driving and steering signals are output based on commands from the DNN to autonomously steer or maneuver the vehicle to the designed object for coupling. For example, output commands 407, e.g., steering commands, from RNN 406 that are forwarded to steering control system 105. Steering control system 105 can receive a continuous stream of steering commands from RNN 406 to autonomously steer or maneuver vehicle 110 to a designated object for coupling, e.g., wireless charging pad 117 or other designated objects described herein.

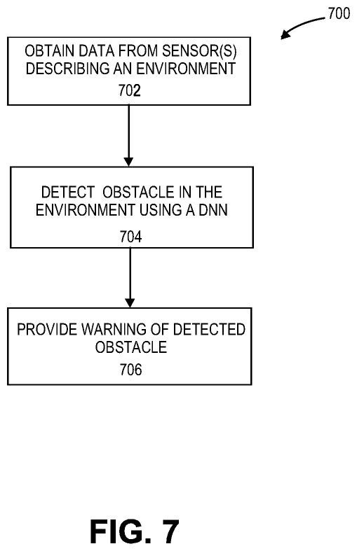

FIG. 7 illustrates one example of a flow diagram of an operation to detect an obstacle or other object in the environment of a vehicle. Operation 700 includes operations 702, 704 and 706, which can be implemented by driving assistance system 107 and 400 of FIGS. 1A and 4 within vehicle 100.

At operation 702, data from sensors describing an environment are obtained. For example, images from front and back vision sensors 106 and 112 are obtained. Alternatively, data from other sensors can be obtained such as sensors 118-1 and 118-2 and LIDAR 119. The sensor data is fed into driving assistance system 107.

At operation 704, an obstacle or other object is detected in the environment using a DNN. For example, sub-branch network 404 can be branch or subnetwork of CNN 402 with a subset of convolutional layers 504 and 506 and fully connected layers 508. Sub-branch network 404 can be configured to detect obstacles or other objects in the environment of vehicle 110. For one example, images from front vision sensors 106 and rear vision sensors 112 may show an obstacle (e.g., a person or another vehicle) within the environment of vehicle 110. Sub-branch network 404 can be modeled and trained to detect such obstacles and provide a warning to a driver. Alternatively, sub-branch network 404 can be trained and configured to detect other types of objects such as a charging pad, cables, segmentation of the ground in the surrounding environment, parking lines, etc. The detection of such the other objects can take into consideration as a loss during training of the CNN 402.

At operation 706, a warning is provided of the detected obstacle. For example, referring to FIG. 2, during charging, display area 1 (214) or 3 (218) of display 202 can show a warning of the obstacle or other object to a driver or passenger of vehicle 110. The warning can also be received by driving assistance system 107 to account for the obstacle or other object in coupling with the designated object.

In the foregoing specification, the invention has been described with reference to specific examples and exemplary embodiments thereof. It will, however, be evident that various modifications and changes may be made thereto without departing from the broader spirit and scope of disclosed examples and embodiments. The specification and drawings are, accordingly, to be regarded in an illustrative rather than a restrictive sense.

What is claimed is:

1. A vehicle data processing system comprising:
one or more sensors to obtain data describing an environment around a vehicle; and
a driving assistance system coupled to the one or more sensors and configured to
detect and track a designated object in the environment around the vehicle based on the captured data from the one or more sensors using a deep neural network (DNN), and
output commands based on the detected and tracked designated object from the DNN used to autonomously steer or maneuver the vehicle to the designated object in the environment to enable coupling of the vehicle with the designated object.

2. The vehicle data processing system of claim 1, wherein the designated object includes a charging pad of a wireless charging system.

3. The vehicle data processing system of claim 1, wherein the designated object includes a trailer hitch component, cable charging component, gas filling component or other device or component for coupling with vehicle.

4. The vehicle data processing of claim 1, wherein the DNN includes a convolutional neural network (CNN) to detect the designated object in the data from the one or more sensors and a recurrent neural network (RNN) coupled to the CNN to track the designated object and output commands including steering commands, braking commands, transmission commands, switching-off motor commands, or other commands to subsystems of the vehicle.

5. The vehicle data processing system of claim 4, further comprising:
a steering control system coupled to the driving assistance system and configured to receive steering commands from the RNN, and
output steering signals based on the steering commands such as forward, backward, stop, velocity, yaw direction, yaw velocity, or other steering signals to respective subsystems of the vehicle to autonomously steer or maneuver the vehicle to the designated object in the environment and enable coupling of the vehicle with the designated object.

6. The vehicle data processing system of claim 4, wherein the DNN further includes a sub-network to detect one or more obstacles or other objects in the environment based on the data from the one or more sensors.

7. The vehicle data processing system of claim 6, wherein the driving assistance system is further configured to a provide a warning on a display of the vehicle.

8. The vehicle data processing system of claim 1, wherein the one or more sensors include at least one vision sensor having a camera, a light detection and ranging device (LIDAR), ultrasonic device, inertia measurement unit (IMU), and/or global positioning device (GPS) device.

9. The vehicle data processing system of claim 5, wherein the camera is to capture image data surrounding the vehicle including the designated object, the LIDAR is to measure distance to the designated object by illuminating the designated object with a laser, the ultrasonic device is to detect objects and distances using ultrasound waves, the IMU is to collect angular velocity and linear acceleration data, and the GPS device is obtain GPS data and calculate geographical positioning of the vehicle.

10. The vehicle processing system of claim 1, wherein the driving assistance system is to receive initialization information regarding location of the designated object from a database in a cloud-based system.

11. The vehicle processing system of claim 9, wherein information regarding the designated object is updated in the database.

12. A vehicle data processing system comprising:
one or more sensors to obtain data describing an environment around a vehicle; and
a plurality of subsystems including a driving assistance subsystem and steering control subsystem, and wherein
the driving assistance system is coupled to the one or more sensors and configured to detect and track a designated object in the environment around the vehicle based on the captured data from the one or more sensors using a deep neural network (DNN), and output commands to a plurality of subsystems including the steering control system based on the detected and tracked designated object from the DNN,
the steering control system receives commands from the DNN and outputs steering signals to subsystems of the vehicle to autonomously steer or maneuver the vehicle to the designated object in the environment and enable coupling of the vehicle with the designated object.

13. The vehicle of claim 12, wherein the designated object includes a charging pad of a wireless charging system.

14. The vehicle of claim 12, wherein the designated object includes a trailer hitch component, cable charging component, gas filling component or other device or component for coupling with vehicle.

15. The vehicle of claim 12, wherein the DNN includes a convolutional neural network (CNN) to detect the designated object in the data from the one or more sensors and a recurrent neural network (RNN) to track the designated object and output commands including steering commands, braking commands, transmission commands, switching-off motor commands, or other commands to subsystems of the vehicle.

16. The vehicle of claim 15, wherein the DNN further includes a sub-network to detect one or more obstacles or other objects in the environment based on the data from the one or more sensors.

17. The vehicle of claim 16, wherein the driving assistance system is further configured to a provide a warning on a display of the vehicle based on one or more detected obstacles.

18. The vehicle of claim 12, wherein the steering control system outputs steering signals such as forward, backward, stop, velocity, yaw direction, yaw velocity, or other steering signals to respective subsystems of the vehicle to autonomously steer or maneuver the vehicle to the designated object in the environment and enable coupling of the vehicle with the designated object.

19. The vehicle of claim 12, wherein the one or more sensors include at least one vision sensor having a camera, a light detection and ranging device (LIDAR), ultrasonic device, inertia measurement unit (IMU), and/or global positioning device (GPS) device.

20. The vehicle of claim 19, wherein the camera is to capture image data surrounding the vehicle including the designated object, the LIDAR is to measure distance to the designated object by illuminating the designated object with a laser, the ultrasonic device is to detect objects and distances using ultrasound waves, the IMU is to collect angular velocity and linear acceleration data, and the GPS device is to obtain GPS data and calculate geographical positioning of the vehicle.

21. The vehicle of claim 12, wherein the driving assistance system is to receive initialization information regarding location of the designated object from a database.

22. The vehicle of claim 21, wherein information regarding the designated object is updated in the database.
